(19) United States
(12) Patent Application Publication
(10) Pub. No.: US 2026/0079329 A1
(43) Pub. Date: Mar. 19, 2026

(54) IMAGING LENS

(71) Applicant: GUANGZHOU LUXVISIONS INNOVATION TECHNOLOGY LIMITED, Guangzhou City (CN)

(72) Inventor: Chuan-Hui Liu, Guangzhou City (CN)

(73) Assignee: GUANGZHOU LUXVISIONS INNOVATION TECHNOLOGY LIMITED, Guangzhou City (CN)

(21) Appl. No.: 19/173,824

(22) Filed: Apr. 9, 2025

(30) Foreign Application Priority Data
Sep. 18, 2024 (CN) 202411301363.9

(51) Int. Cl. G02B 13/00; G02B 13/02; G02B 15/14

(52) U.S. Cl. CPC G02B 13/009; G02B 13/0045; G02B 13/02; G02B 15/1421

(57) ABSTRACT

An imaging lens includes a first lens group and a second lens group. The first lens group has positive refracting power and includes a first lens, a second lens and a third lens having refracting power. The second lens group has negative refracting power and includes a fourth lens, a fifth lens and a sixth lens having refracting power. The first lens to the sixth lens are disposed in sequence from an object side to an image side of the imaging lens. When a light beam enters the imaging lens from the object side of the imaging lens and reaches an image plane, the light beam passes through a total of six lenses with refracting power. The first lens group may be switched to a third lens group to achieve high resolution and zoom ratio within a compact volume.

### CROSS-REFERENCE TO RELATED APPLICATION

This application claims the priority benefit of China application serial no. 202411301363.9, filed on Sep. 18, 2024. The entirety of the above-mentioned patent application is hereby incorporated by reference herein and made a part of this specification.

### BACKGROUND

### Technical Field

The disclosure relates to an optical device, and in particular relates to an imaging lens.

### Description of Related Art

With the rapid evolution of electronic device specifications, optical imaging lenses, as one of the critical components, are also developing in increasingly diverse ways. For imaging lenses of electronic devices, not only are high resolution and zoom ratio required, but smaller volume is also pursued. However, imaging lenses available in the market typically achieve zoom functionality only through the movement of lenses on the optical axis, necessitating a large total track length (TTL) to provide high zoom ratio.

### SUMMARY

An imaging lens which may achieve high resolution and zoom ratio within a compact volume is provided in the disclosure.

According to an embodiment of the disclosure, an imaging lens is provided, including a first lens group and a second lens group. The first lens group has positive refracting power and includes a first lens, a second lens and a third lens having refracting power. The second lens group has negative refracting power and includes a fourth lens, a fifth lens and a sixth lens having refracting power. The first lens to the sixth lens are disposed in sequence from an object side to an image side of the imaging lens. When a light beam enters the imaging lens from the object side of the imaging lens and reaches an image plane, the light beam passes through a total of six lenses with refracting power.

According to an embodiment of the disclosure, the first lens group may be switched to a third lens group.

Based on the above, the imaging lens provided by the embodiment of the disclosure may switch lens groups to achieve the purpose of zooming. This achieves high resolution and zoom ratio within a compact volume.

In order to make the above-mentioned features and advantages of the disclosure comprehensible, embodiments accompanied with drawings are described in detail below.

### BRIEF DESCRIPTION OF THE DRAWINGS

FIG. 1A and FIG. 1B are schematic diagrams respectively showing an imaging lens in a wide-angle mode and in a telephoto mode according to a first embodiment and a second embodiment of the disclosure.

FIG. 2 and FIG. 3 are optical schematic diagrams showing an imaging lens in a wide-angle mode according to a first embodiment of the disclosure.

FIG. 4A, FIG. 4B and FIG. 4C respectively show a schematic diagram of field curvature in the meridional direction (also referred to as meridian direction), a schematic diagram of field curvature in the sagittal direction and a schematic diagram of distortion when the focal length of the imaging lens of the first embodiment is infinite.

FIG. 5A, FIG. 5B and FIG. 5C respectively show a schematic diagram of field curvature in the meridional direction, a schematic diagram of field curvature in the sagittal direction and a schematic diagram of distortion when the focal length of the imaging lens of the first embodiment is 10 cm.

FIG. 6 and FIG. 7 are optical schematic diagrams showing an imaging lens in a telephoto mode according to a first embodiment of the disclosure.

FIG. 8A, FIG. 8B and FIG. 8C respectively show a schematic diagram of field curvature in the meridional direction, a schematic diagram of field curvature in the sagittal direction and a schematic diagram of distortion when the focal length of the imaging lens of the first embodiment is infinite.

FIG. 9A, FIG. 9B and FIG. 9C respectively show a schematic diagram of field curvature in the meridional direction, a schematic diagram of field curvature in the sagittal direction and a schematic diagram of distortion when the focal length of the imaging lens of the first embodiment is 10 cm.

FIG. 10 and FIG. 11 are optical schematic diagrams showing an imaging lens in a wide-angle mode according to a second embodiment of the disclosure.

FIG. 12A, FIG. 12B and FIG. 12C respectively show a schematic diagram of field curvature in the meridional direction, a schematic diagram of field curvature in the sagittal direction and a schematic diagram of distortion when the focal length of the imaging lens of the second embodiment is infinite.

FIG. 13A, FIG. 13B and FIG. 13C respectively show a schematic diagram of field curvature in the meridional direction, a schematic diagram of field curvature in the sagittal direction and a schematic diagram of distortion when the focal length of the imaging lens of the second embodiment is 50 cm.

FIG. 14 and FIG. 15 are optical schematic diagrams showing an imaging lens in a telephoto mode according to a second embodiment of the disclosure.

FIG. 16A, FIG. 16B and FIG. 16C respectively show a schematic diagram of field curvature in the meridional direction, a schematic diagram of field curvature in the sagittal direction and a schematic diagram of distortion when the focal length of the imaging lens of the second embodiment is infinite.

FIG. 17A, FIG. 17B and FIG. 17C respectively show a schematic diagram of field curvature in the meridional direction, a schematic diagram of field curvature in the sagittal direction and a schematic diagram of distortion when the focal length of the imaging lens of the second embodiment is 10 cm.

### DETAILED DESCRIPTION OF DISCLOSED EMBODIMENTS

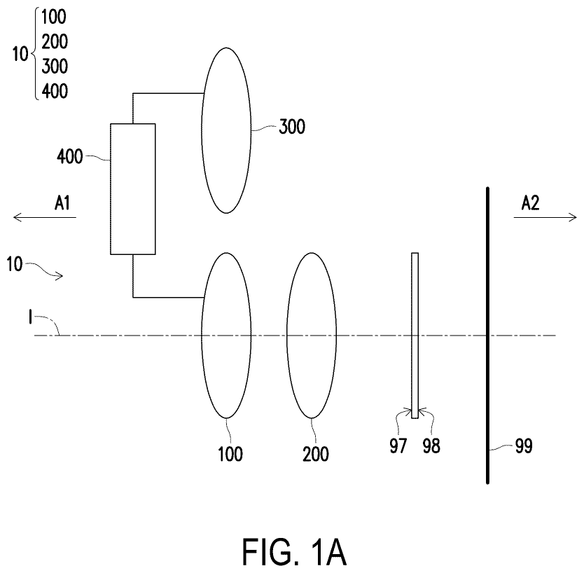

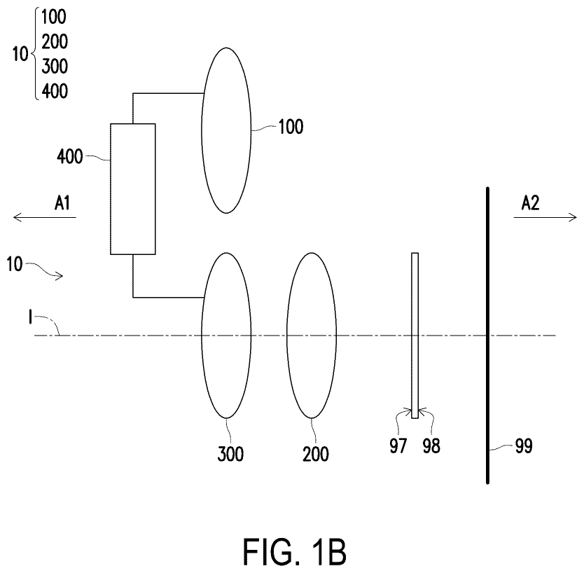

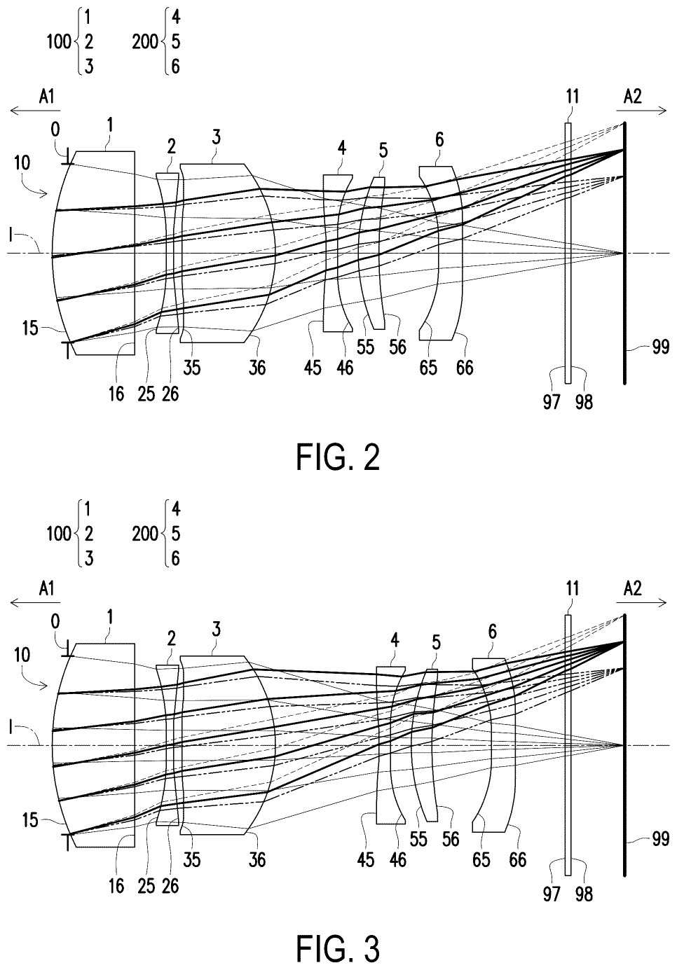

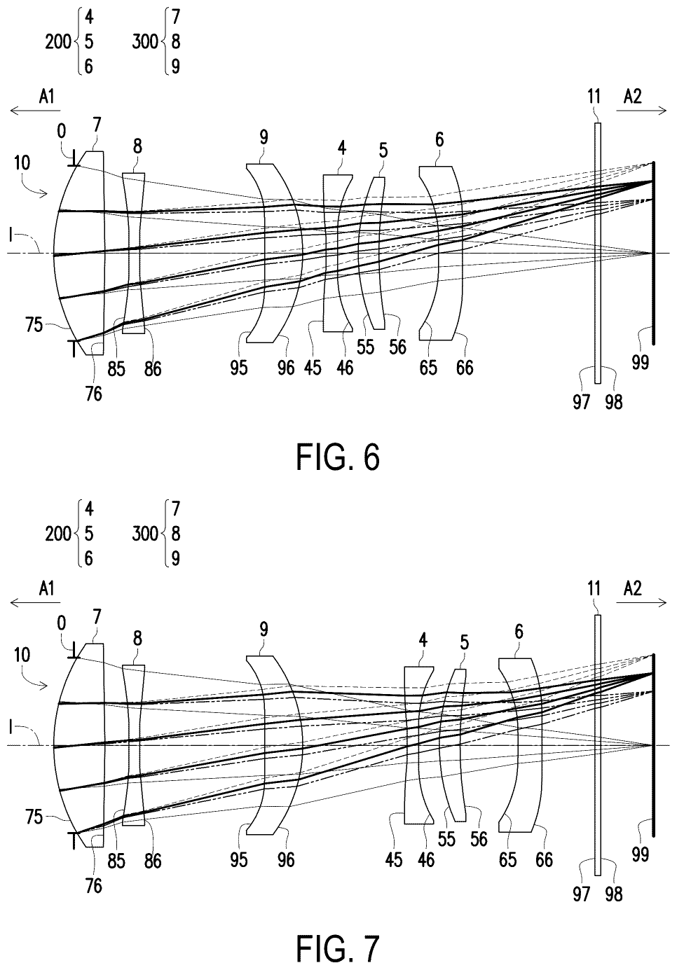

Please refer to FIG. 1A, FIG. 1B, FIG. 2, FIG. 3, FIG. 6, and FIG. 7. FIG. 1A and FIG. 1B are schematic diagrams respectively showing an imaging lens in a wide-angle mode and in a telephoto mode according to a first embodiment and a second embodiment of the disclosure. FIG. 2 and FIG. 3 are optical schematic diagrams showing an imaging lens in a wide-angle mode according to a first embodiment of the disclosure. FIG. 6 and FIG. 7 are optical schematic diagrams showing an imaging lens in a telephoto mode according to a first embodiment of the disclosure.

As shown in FIG. 1A and FIG. 1B, an imaging lens 10 according to a first embodiment of the disclosure includes a first lens group 100, a second lens group 200, a third lens group 300, and a lens group replacement mechanism 400. The lens group replacement mechanism 400 is configured to replace the first lens group 100 with the third lens group 300 on the optical axis I of the imaging lens 10, and to replace the third lens group 300 with the first lens group 100 on the optical axis I. The first lens group 100 includes lens 1, lens 2 and lens 3, the second lens group 200 includes lens 4, lens 5 and lens 6, and the third lens group 300 includes lens 7, lens 8 and lens 9.

When the first lens group 100 and the second lens group 200 are disposed on the optical axis I, as shown in FIG. 1A, FIG. 2 and FIG. 3, the imaging lens 10 is in a wide-angle mode. FIG. 2 is a schematic diagram showing the imaging lens 10 in the wide-angle mode with an infinite focal length, and FIG. 3 is a schematic diagram showing the imaging lens 10 in the wide-angle mode with close-range focusing (e.g., a focal length of 10 cm). As shown in FIG. 2 and FIG. 3, when the imaging lens 10 focuses in the wide-angle mode, the second lens group 200 moves as a group along the optical axis I, and the first lens group 100 does not move. When the second lens group 200 moves as a group along the optical axis I, the spacing between the lens 4, lens 5 and lens 6 remain unchanged.

When the third lens group 300 and the second lens group 200 are disposed on the optical axis I, as shown in FIG. 1B, FIG. 6 and FIG. 7, the imaging lens 10 is in a telephoto mode. FIG. 6 is a schematic diagram showing the imaging lens 10 in the telephoto mode with an infinite focal length, and FIG. 7 is a schematic diagram showing the imaging lens 10 in the telephoto mode with close-range focusing (e.g., a focal length of 10 cm). As shown in FIG. 6 and FIG. 7, when the imaging lens 10 focuses in the telephoto mode, the second lens group 200 moves as a group along the optical axis I, and the third lens group 300 does not move. When the second lens group 200 moves as a group along the optical axis I, the spacing between the lens 4, lens 5 and lens 6 remain unchanged.

Optical schematic diagrams of the imaging lens 10 in the wide-angle mode according to the first embodiment of the disclosure are shown in FIG. 2 and FIG. 3. The imaging lens 10 includes an aperture 0, a lens 1, a lens 2, a lens 3, a lens 4, a lens 5, a lens 6 and a filter 11 in sequence along the optical axis I of the imaging lens 10 from the object side A1 to the image side A2. When a light beam emitted by an object to be photographed enters the imaging lens 10 and sequentially passes through the aperture 0, the lens 1, the lens 2, the lens 3, the lens 4, the lens 5, the lens 6 and the filter 11, an image is formed on an image plane 99. The filter 11 is, for example, an infrared cut-off filter, which allows light beam with appropriate wavelength (e.g. infrared light or visible light) to pass through while filtering out the infrared wavelength bands that are intended to be eliminated. The filter 11 is disposed between the lens 6 and the image plane 99. It should be clarified that the object side A1 is the side facing the object to be photographed, and the image side A2 is the side facing the image plane 99.

In this embodiment, the lens 1, the lens 2, the lens 3, the lens 4, the lens 5, the lens 6 and the filter 11 of the optical imaging lens 10 each have an object side surface 15, 25, 35, 45, 55, 65, 97 facing the object side A1 and allowing an imaging light beam to pass therethrough, and an image side surface 16, 26, 36, 46, 56, 66, 98 facing the image side A2 and allowing the imaging light beam to pass therethrough. In this embodiment, the aperture 0 is disposed on the object side A1 of the lens 1.

The first lens group 100 has positive refracting power and an effective focal length of 11.32 mm. The lens 1 has positive refracting power and an effective focal length of 16.95 mm. The optical axis region of the object side surface 15 is a convex surface, the optical axis region of the image side surface 16 is a convex surface, and both the object side surface 15 and the image side surface 16 are aspheric surfaces. The lens 2 has negative refracting power. The optical axis region of the object side surface 25 is a concave surface, the optical axis region of the image side surface 26 is a concave surface, and both the object side surface 25 and the image side surface 26 are aspherical surfaces. The lens 3 has positive refracting power. The optical axis region of the object side surface 35 is a convex surface, the optical axis region of the image side surface 36 is a convex surface, and both the object side surface 35 and the image side surface 36 are aspherical surfaces.

The second lens group 200 has negative refracting power. The lens 4 has negative refracting power. The optical axis region of the object side surface 45 is a concave surface, the optical axis region of the image side surface 46 is a concave surface, and both the object side surface 45 and the image side surface 46 are aspherical surfaces. The lens 5 has positive refracting power. The optical axis region of the object side surface 55 is a convex surface, the optical axis region of the image side surface 56 is a concave surface, and both the object side surface 55 and the image side surface 56 are aspherical surfaces. The lens 6 has negative refracting power. The optical axis region of the object side surface 65 is a concave surface, the optical axis region of the image side surface 66 is a convex surface, and both the object side surface 65 and the image side surface 66 are aspherical surfaces.

Other detailed optical data of the imaging lens 10 of the first embodiment in the wide-angle mode are shown in Table 1 and Table 2. The field of view (FOV) of the optical imaging lens 10 is 28.00, the aperture value (F number) is 2.9, the total track length (TTL) of the lens (the distance from the object side surface 15 of the lens 1 to the image plane 99 on the optical axis I) is 22.337 mm, and the image height (mgH) is 5.12 mm.

TABLE 1

| | | Radius of | | | |
|---|---|---|---|---|---|
| | | curvature | Spacing | Refractive | Abbe |
| Element | Surface | (mm) | (mm) | index | number |
| Object | | infinite | d0 | | |
| Aperture 0 | | infinite | −0.600 | | |
| Lens 1 | object side | 9.16 | 2.599 | 1.545 | 55.987 |
| | surface 15 | | | | |
| | image side | −365.99 | 1.077 | | |
| | surface 16 | | | | |
| Lens 2 | object side | −11.90 | 0.400 | 1.642 | 22.409 |
| | surface 25 | | | | |
| | image side | 23.09 | 0.354 | | |
| | surface 26 | | | | |
| Lens 3 | object side | 16.05 | 3.631 | 1.545 | 55.987 |
| | surface 35 | | | | |
| | image side | −6.02 | d7 | | |
| | surface 36 | | | | |
| Lens 4 | object side | −6.53 | 0.400 | 1.545 | 55.987 |
| | surface 45 | | | | |
| | image side | 34.42 | 0.782 | | |
| | surface 46 | | | | |
| Lens 5 | object side | 5.40 | 0.746 | 1.671 | 19.276 |
| | surface 55 | | | | |
| | image side | 10.03 | 2.169 | | |
| | surface 56 | | | | |
| Lens 6 | object side | −10.88 | 1.059 | 1.671 | 19.276 |
| | surface 65 | | | | |
| | image side | −71.03 | d13 | | |
| | surface 66 | | | | |
| Filter 11 | object side | infinite | 0.210 | 1.517 | 64.167 |
| | surface 97 | | | | |
| | image side | infinite | 2.100 | | |
| | surface 98 | | | | |
| | image plane 99 | infinite | | | |

TABLE 2

| Focus state | State 1 | State 2 |
|---|---|---|
| d0 | infinite | 100.00 |
| d7 | 2.00 | 3.82 |
| d13 | 4.81 | 2.99 |

In Table 1 and Table 2, the spacing of the object side surface 15 (2.599 mm as shown in Table 1) is the thickness of the lens 1 on the optical axis I, and the spacing of the image side surface 16 (1.077 mm as shown in Table 1) is the distance between the image side surface 16 of the lens 1 and the object side surface 25 of the lens 2 on the optical axis I, that is, the gap between the lens 1 and the lens 2 on the optical axis I, and so on. The object spacing d0 is the focal length of the imaging lens 10. Table 2 describes the values of d7 and d13 in Table 1 when the focal length of the imaging lens 10 is infinite (state 1) and 10 cm (state 2). State 1 in Table 2 corresponds to FIG. 2, and state 2 in Table 2 corresponds to FIG. 3.

In this embodiment, the object side surfaces 15, 25, 35, 45, 55, 65 and the image side surfaces 16, 26, 36, 46, 56, 66 of the lens 1, the lens 2, the lens 3, the lens 4, the lens 5, and the lens 6 are all aspherical surfaces, and these aspherical surfaces are defined according to the following formula:

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{2 i} \times {y}^{2 i} \qquad ( 1 )$$

Y: the distance between a point on the aspheric curve and the optical axis.
Z: the depth of the aspheric surface, that is, the vertical distance between the point on the aspheric surface whose distance from the optical axis is Y, and the tangent plane that is tangent to the apex of the aspheric surface on the optical axis.
R: the radius of curvature of the lens surface.
K: the conical coefficient.
a₂ᵢ: 2i^{th} order aspheric coefficient.

The conical coefficient K and various aspheric coefficients of the aspheric surface in Formula (1) of this embodiment are shown in Table 3. The number 15 in Table 3 indicates the aspheric coefficient of the object side surface 15 of the lens 1, and the other numbers may be deduced by analogy.

TABLE 3

| Surface | K | a₄ | a₆ | a₈ | a₁₀ |
|---|---|---|---|---|---|
| 15 | 0 | 1.5551E−01 | −3.7272E−01 | 7.9516E−01 | −7.3630E+00 |
| 16 | 0 | 1.3385E+00 | −2.1817E+00 | −4.3389E+01 | 3.0268E+02 |
| 25 | 0 | 6.0459E+00 | −5.7810E+01 | 3.3741E+02 | −1.3892E+03 |
| 26 | 0 | 2.3046E+00 | −3.3202E+01 | 2.1196E+02 | −7.2666E+02 |
| 35 | 0 | −2.4212E+00 | −3.0743E+00 | 5.9902E+01 | −2.6628E+02 |
| 36 | 0 | −1.6900E−01 | −6.9083E−01 | 4.8888E+00 | −2.2577E+01 |
| 45 | 0 | 7.8796E+00 | −1.6121E+01 | −7.7744E+00 | 1.7439E+02 |
| 46 | 0 | 4.6291E+00 | 1.9249E+01 | −2.5557E+02 | 1.2347E+03 |
| 55 | 0 | −5.3738E+00 | 3.3968E+01 | −1.6719E+02 | 5.2594E+02 |
| 56 | 0 | −3.4880E+00 | 2.2157E+01 | −1.1272E+02 | 3.6854E+02 |
| 65 | 0 | −7.3136E+00 | 3.1821E+01 | −1.5719E+02 | 5.7651E+02 |
| 66 | 0 | −5.7029E+00 | 1.1342E+01 | −2.7151E+00 | −2.3643E+02 |

| Surface | a₁₂ | a₁₄ | a₁₆ | a₁₈ | a₂₀ |
|---|---|---|---|---|---|
| 15 | 3.2091E+01 | −6.5682E+01 | 7.8147E+01 | −5.5936E+01 | 1.7909E+01 |
| 16 | −1.0294E+03 | 2.0436E+03 | −2.3504E+03 | 1.4361E+03 | −3.5877E+02 |
| 25 | 3.7098E+03 | −6.2054E+03 | 6.2426E+03 | −3.4345E+03 | 7.9099E+02 |
| 26 | 1.3577E+03 | −1.3413E+03 | 5.8928E+02 | −8.0924E+00 | −5.1304E+01 |
| 35 | 6.4582E+02 | −1.0900E+03 | 1.2513E+03 | −8.1942E+02 | 2.2250E+02 |
| 36 | 6.5297E+01 | −1.3090E+02 | 1.6568E+02 | −1.1767E+02 | 3.5139E+01 |
| 45 | −5.2496E+02 | 7.5775E+02 | −5.4310E+02 | 1.5292E+02 | 9.5618E−01 |
| 46 | −3.3473E+03 | 5.4252E+03 | −5.2252E+03 | 2.7620E+03 | −6.1696E+02 |
| 55 | −1.0993E+03 | 1.5128E+03 | −1.2851E+03 | 5.9972E+02 | −1.1620E+02 |
| 56 | −8.2674E+02 | 1.2461E+03 | −1.1554E+03 | 5.8917E+02 | −1.2735E+02 |
| 65 | −1.5260E+03 | 2.7586E+03 | −3.1407E+03 | 1.9792E+03 | −5.1802E+02 |
| 66 | 1.2823E+03 | −3.2555E+03 | 4.3950E+03 | −3.0375E+03 | 8.4459E+02 |

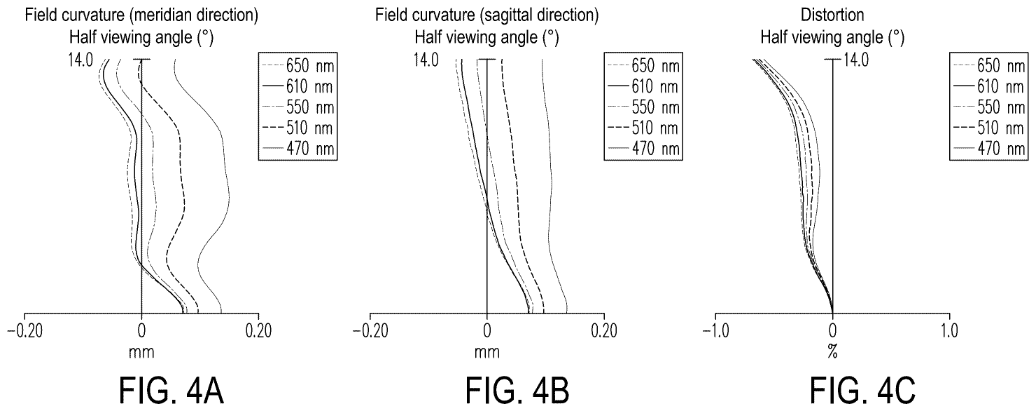

Referring to FIG. 4A, FIG. 4B and FIG. 4C, which respectively show a schematic diagram of field curvature in the meridional direction, a schematic diagram of field curvature in the sagittal direction and a schematic diagram of distortion when the focal length of the imaging lens 10 of the first embodiment is infinite (corresponding to state 1 and FIG. 2). As shown in FIG. 4A and FIG. 4B, when light with wavelengths of 470 nm, 510 nm, 555 nm, 610 nm and 650 nm respectively enter the imaging lens 10, the field curvatures at different field of views are within the range of ±0.16 mm. As shown in FIG. 4C, the distortion aberration of the imaging lens 10 is maintained within the range of ±0.8%.

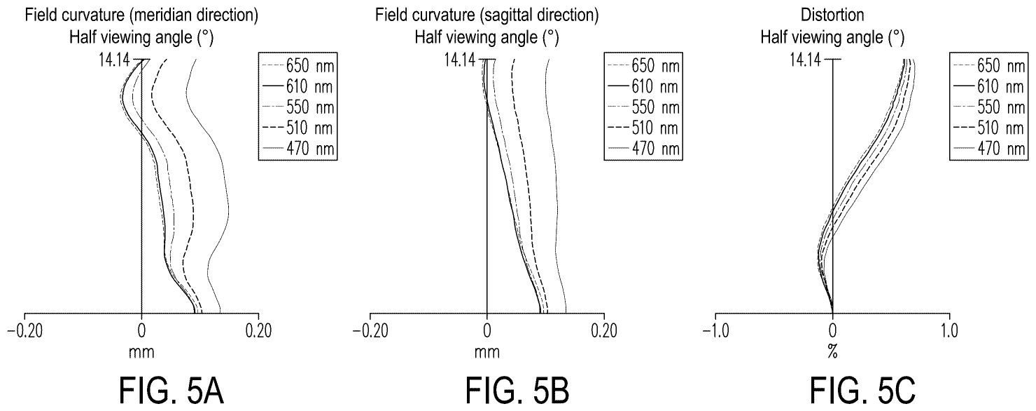

Referring to FIG. 5A, FIG. 5B and FIG. 5C, which respectively show a schematic diagram of field curvature in the meridional direction, a schematic diagram of field curvature in the sagittal direction and a schematic diagram of distortion when the focal length of the imaging lens 10 of the first embodiment is 10 cm (corresponding to state 2 and FIG. 3). As shown in FIG. 5A and FIG. 5B, when light with wavelengths of 470 nm, 510 nm, 555 nm, 610 nm and 650 nm respectively enter the imaging lens 10, the field curvatures at different field of views are within the range of ±0.16 mm. As shown in FIG. 5C, the distortion aberration of the imaging lens 10 is maintained within the range of ±0.8%.

FIG. 4A to FIG. 5C illustrate that the imaging lens 10 according to the first embodiment of the disclosure has good imaging quality in the wide-angle mode and a short total track length.

Optical schematic diagrams of the imaging lens 10 in the telephoto mode according to the first embodiment of the disclosure are shown in FIG. 6 and FIG. 7. The imaging lens 10 includes an aperture 0, a lens 7, a lens 8, a lens 9, a lens 4, a lens 5, a lens 6 and a filter 11 in sequence along the optical axis I of the imaging lens 10 from the object side A1 to the image side A2. When a light beam emitted by an object to be photographed enters the imaging lens 10 and sequentially passes through the aperture 0, the lens 7, the lens 8, the lens 9, the lens 4, the lens 5, the lens 6 and the filter 11, an image is formed on an image plane 99. The filter 11 is disposed between the lens 6 and the image plane 99.

In this embodiment, the lens 7, the lens 8, the lens 9, the lens 4, the lens 5, the lens 6 and the filter 11 of the optical imaging lens 10 each have an object side surface 75, 85, 95, 45, 55, 65, 97 facing the object side A1 and allowing an imaging light beam to pass therethrough, and an image side surface 76, 86, 96, 46, 56, 66, 98 facing the image side A2 and allowing the imaging light beam to pass therethrough. In this embodiment, the aperture 0 is disposed on the object side A1 of the lens 7.

The third lens group 300 has positive refracting power and an effective focal length of 14.06 mm. The lens 7 has positive refracting power and an effective focal length of 11.38 mm. The optical axis region of the object side surface 75 is a convex surface, the optical axis region of the image side surface 76 is a convex surface, and both the object side surface 75 and the image side surface 76 are aspheric surfaces. The lens 8 has negative refracting power. The optical axis region of the object side surface 85 is a concave surface, the optical axis region of the image side surface 86 is a concave surface, and both the object side surface 85 and the image side surface 86 are aspherical surfaces. The lens 9 has positive refracting power. The optical axis region of the object side surface 95 is a concave surface, the optical axis region of the image side surface 96 is a convex surface, and both the object side surface 95 and the image side surface 96 are aspherical surfaces.

Other detailed optical data of the imaging lens 10 of the first embodiment in the telephoto mode are shown in Table 4 and Table 5. The field of view (FOV) of the optical imaging lens 10 is 15.0°, the aperture value (F number) is 3.8, the total track length (TTL) of the lens (the distance from the object side surface 75 of the lens 7 to the image plane 99 on the optical axis I) is 24.00 mm, and the image height (ImgH) is 3.60 mm.

TABLE 4

| | | Radius of | | | |
|---|---|---|---|---|---|
| | | curvature | Spacing | Refractive | Abbe |
| Element | Surface | (mm) | (mm) | index | number |
| Object | | infinite | d0 | | |
| Aperture 0 | | infinite | −1.000 | | |
| Lens 7 | object side | 7.53 | 2.030 | 1.545 | 55.987 |
| | surface 75 | | | | |
| | image side | −29.26 | 0.952 | | |
| | surface 76 | | | | |
| Lens 8 | object side | −16.91 | 0.586 | 1.642 | 22.409 |
| | surface 85 | | | | |
| | image side | 36.19 | 5.169 | | |
| | surface 86 | | | | |
| Lens 9 | object side | −39.87 | 1.883 | 1.545 | 55.987 |
| | surface 95 | | | | |
| | image side | −8.48 | d7 | | |
| | surface 96 | | | | |
| Lens 4 | object side | −6.53 | 0.400 | 1.545 | 55.987 |
| | surface 45 | | | | |
| | image side | 34.42 | 0.782 | | |
| | surface 46 | | | | |
| Lens 5 | object side | 5.40 | 0.746 | 1.671 | 19.276 |
| | surface 55 | | | | |
| | image side | 10.03 | 2.769 | | |
| | surface 56 | | | | |
| Lens 6 | object side | −10.88 | 1.059 | 1.671 | 19.276 |
| | surface 65 | | | | |
| | image side | −71.03 | d13 | | |
| | surface 66 | | | | |
| Filter 11 | object side | infinite | 0.210 | 1.517 | 64.767 |
| | surface 97 | | | | |
| | image side | infinite | 2.100 | | |
| | surface 98 | | | | |
| | image plane 99 | infinite | | | |

TABLE 5

| Focus state | State 1 | State 2 |
|---|---|---|
| d0 | infinite | 100.00 |
| d7 | 1.00 | 4.36 |
| d13 | 4.91 | 1.56 |

In Table 4 and Table 5, the spacing of the object side surface 75 (2.030 mm as shown in Table 4) is the thickness of the lens 7 on the optical axis I, and the spacing of the image side surface 76 (0.952 mm as shown in Table 4) is the distance between the image side surface 76 of the lens 7 and the object side surface 85 of the lens 8 on the optical axis I, that is, the gap between the lens 7 and the lens 8 on the optical axis I, and so on. The object spacing d0 is the focal length of the imaging lens 10. Table 5 describes the values of d7 and d13 in Table 4 when the focal length of the imaging lens 10 is infinite (state 1) and 10 cm (state 2). State 1 in Table 5 corresponds to FIG. 6, and state 2 in Table 5 corresponds to FIG. 7.

In this embodiment, the object side surfaces 75, 85, 95, 45, 55, 65 and the image side surfaces 76, 86, 96, 46, 56, 66 of the lens 7, the lens 8, the lens 9, the lens 4, the lens 5, and the lens 6 are all aspherical surfaces. The conical coefficient K and various aspheric coefficients of the aspheric surface of the imaging lens 10 in Formula (1) of this embodiment are shown in Table 6. The number 75 in Table 6 indicates the aspheric coefficient of the object side surface 75 of the lens 7, and the other numbers may be deduced by analogy.

TABLE 6

| Surface | K | a₄ | a₆ | a₈ | a₁₀ |
|---|---|---|---|---|---|
| 75 | 0 | 5.1797E−01 | −6.3817E−01 | −8.2244E+00 | 7.9770E+01 |
| 76 | 0 | 3.0618E+00 | −2.6442E+01 | 1.2205E+02 | −2.3654E+02 |
| 85 | 0 | 6.5617E+00 | −9.7713E+01 | 7.0999E+02 | −2.9139E+03 |
| 86 | 0 | 3.4940E+00 | −5.1939E+01 | 3.6171E+02 | −1.4060E+03 |
| 95 | 0 | −1.5226E+00 | −3.5873E+00 | 1.4484E+01 | −4.2148E+01 |
| 96 | 0 | −9.2274E−01 | −4.0110E+00 | 3.4834E+01 | −1.9930E+02 |
| 45 | 0 | 7.8796E+00 | −1.6121E+01 | −7.7744E+00 | 1.7439E+02 |
| 46 | 0 | 4.6291E+00 | 1.9249E+01 | −2.5557E+02 | 1.2347E+03 |
| 55 | 0 | −5.3738E+00 | 3.3968E+01 | −1.6719E+02 | 5.2594E+02 |
| 56 | 0 | −3.4880E+00 | 2.2157E+01 | −1.1272E+02 | 3.6854E+02 |
| 65 | 0 | −7.3136E+00 | 3.1821E+01 | −1.5719E+02 | 5.7651E+02 |
| 66 | 0 | −5.7029E+00 | 1.1342E+01 | −2.7151E+00 | −2.3643E+02 |

| Surface | a₁₂ | a₁₄ | a₁₆ | a₁₈ | a₂₀ |
|---|---|---|---|---|---|
| 75 | −2.6952E+02 | 5.1948E+02 | −6.0146E+02 | 3.7626E+02 | −9.6041E+01 |
| 76 | 2.6845E+01 | 6.4948E+02 | −1.1121E+03 | 7.7930E+02 | −2.0568E+02 |
| 85 | 7.1832E+03 | −1.0901E+04 | 9.9791E+03 | −5.0485E+03 | 1.0822E+03 |
| 86 | 3.2434E+03 | −4.5190E+03 | 3.7264E+03 | −1.6704E+03 | 3.1318E+02 |
| 95 | −1.4213E+01 | 2.2116E+02 | −3.2098E+02 | 1.7762E+02 | −3.2840E+01 |
| 96 | 6.5632E+02 | −1.3153E+03 | 1.5670E+03 | −1.0046E+03 | 2.6438E+02 |
| 45 | −5.2496E+02 | 7.5775E+02 | −5.4310E+02 | 1.5292E+02 | 9.5618E−01 |
| 46 | −3.3473E+03 | 5.4252E+03 | −5.2252E+03 | 2.7620E+03 | −6.1696E+02 |
| 55 | −1.0993E+03 | 1.5128E+03 | −1.2851E+03 | 5.9972E+02 | −1.1620E+02 |
| 56 | −8.2674E+02 | 1.2461E+03 | −1.1554E+03 | 5.8917E+02 | −1.2735E+02 |
| 65 | −1.5260E+03 | 2.7586E+03 | −3.1407E+03 | 1.9792E+03 | −5.1802E+02 |
| 66 | 1.2823E+03 | −3.2555E+03 | 4.3950E+03 | −3.0375E+03 | 8.4459E+02 |

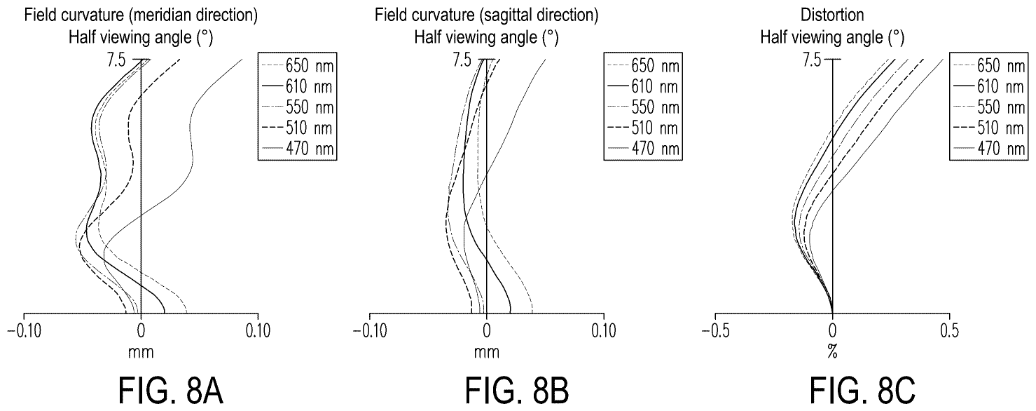

Referring to FIG. 8A, FIG. 8B and FIG. 8C, which respectively show a schematic diagram of field curvature in the meridional direction, a schematic diagram of field curvature in the sagittal direction and a schematic diagram of distortion when the focal length of the imaging lens 10 of the first embodiment is infinite (corresponding to state 1 and FIG. 6). As shown in FIG. 8A and FIG. 8B, when light with wavelengths of 470 nm, 510 nm, 555 nm, 610 nm and 650 nm respectively enter the imaging lens 10, the field curvatures at different field of views are within the range of ±0.10 mm. As shown in FIG. 8C, the distortion aberration of the imaging lens 10 is maintained within the range of ±0.5%.

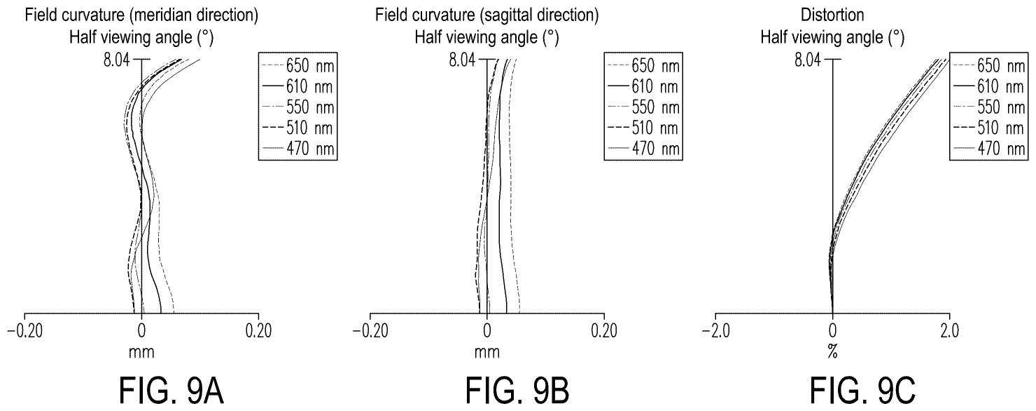

Referring to FIG. 9A, FIG. 9B and FIG. 9C, which respectively show a schematic diagram of field curvature in the meridional direction, a schematic diagram of field curvature in the sagittal direction and a schematic diagram of distortion when the focal length of the imaging lens 10 of the first embodiment is 10 cm (corresponding to state 2 and FIG. 7). As shown in FIG. 9A and FIG. 9B, when light with wavelengths of 470 nm, 510 nm, 555 nm, 610 nm and 650 nm respectively enter the imaging lens 10, the field curvatures at different field of views are within the range of ±0.12 mm. As shown in FIG. 9C, the distortion aberration of the imaging lens 10 is maintained within the range of ±2.0%.

FIG. 8A to FIG. 9C illustrate that the imaging lens 10 according to the first embodiment of the disclosure has good imaging quality in the telephoto mode and a short total track length.

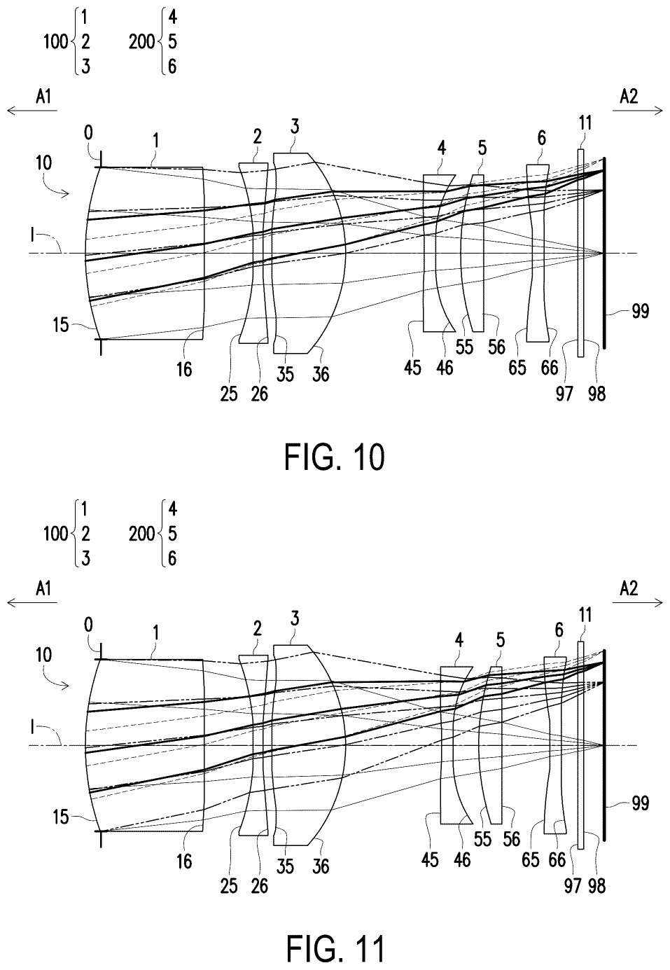

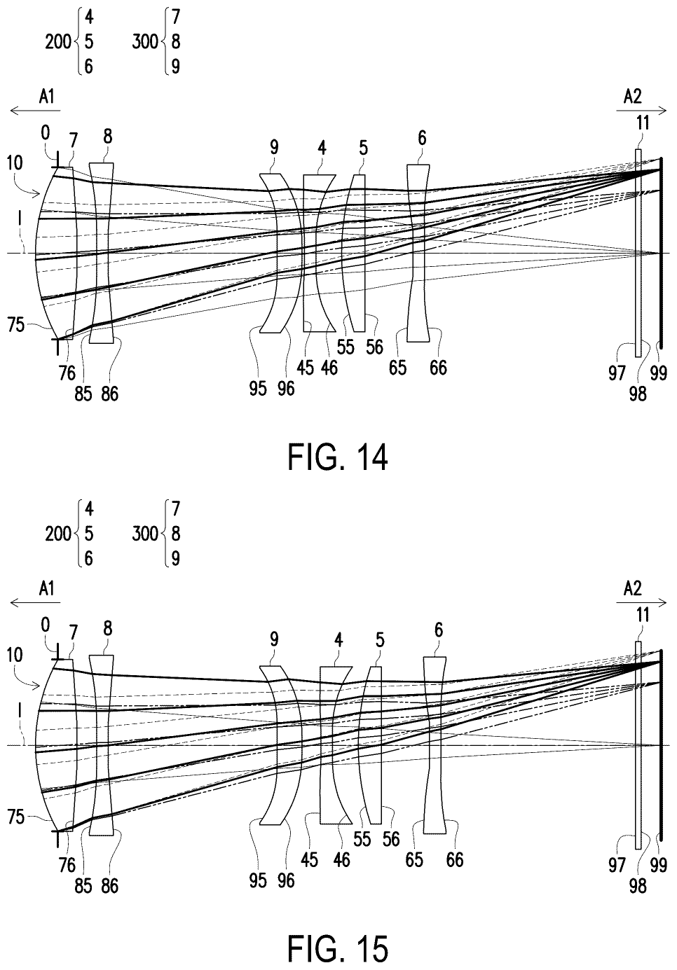

Please refer to FIG. 1A, FIG. 1B, FIG. 10, FIG. 11, FIG. 14, and FIG. 15. FIG. 10 and FIG. 11 are optical schematic diagrams showing an imaging lens in a wide-angle mode according to a second embodiment of the disclosure. FIG. 14 and FIG. 15 are optical schematic diagrams showing an imaging lens in a telephoto mode according to a second embodiment of the disclosure.

As shown in FIG. 1A and FIG. 1B, an imaging lens 10 according to a second embodiment of the disclosure includes a first lens group 100, a second lens group 200, a third lens group 300, and a lens group replacement mechanism 400. The lens group replacement mechanism 400 is configured to replace the first lens group 100 with the third lens group 300 on the optical axis I of the imaging lens 10, and to replace the third lens group 300 with the first lens group 100 on the optical axis I. The first lens group 100 includes lens 1, lens 2 and lens 3, the second lens group 200 includes lens 4, lens 5 and lens 6, and the third lens group 300 includes lens 7, lens 8 and lens 9.

When the first lens group 100 and the second lens group 200 are disposed on the optical axis I, as shown in FIG. 1A, FIG. 10 and FIG. 11, the imaging lens 10 is in a wide-angle mode. FIG. 10 is a schematic diagram showing the imaging lens 10 in the wide-angle mode with an infinite focal length, and FIG. 11 is a schematic diagram showing the imaging lens 10 in the wide-angle mode with close-range focusing (e.g., a focal length of 50 cm). As shown in FIG. 10 and FIG. 11, when the imaging lens 10 focuses in the wide-angle mode, the second lens group 200 moves as a group along the optical axis I, and the first lens group 100 does not move. When the second lens group 200 moves as a group along the optical axis I, the spacing between the lens 4, lens 5 and lens 6 remain unchanged.

When the third lens group 300 and the second lens group 200 are disposed on the optical axis I, as shown in FIG. 1B, FIG. 14 and FIG. 15, the imaging lens 10 is in a telephoto mode. FIG. 14 is a schematic diagram showing the imaging lens 10 in the telephoto mode with an infinite focal length, and FIG. 15 is a schematic diagram showing the imaging lens 10 in the telephoto mode with close-range focusing (e.g., a focal length of 50 cm). As shown in FIG. 14 and FIG. 15, when the imaging lens 10 focuses in the telephoto mode, the second lens group 200 moves as a group along the optical axis I, and the third lens group 300 does not move. When the second lens group 200 moves as a group along the optical axis I, the spacing between the lens 4, lens 5 and lens 6 remain unchanged.

Optical schematic diagrams of the imaging lens 10 in the wide-angle mode according to the second embodiment of the disclosure are shown in FIG. 10 and FIG. 11. The imaging lens 10 includes an aperture 0, a lens 1, a lens 2, a lens 3, a lens 4, a lens 5, a lens 6 and a filter 11 in sequence along the optical axis I of the imaging lens 10 from the object side A1 to the image side A2. When a light beam emitted by an object to be photographed enters the imaging lens 10 and sequentially passes through the aperture 0, the lens 1, the lens 2, the lens 3, the lens 4, the lens 5, the lens 6 and the filter 11, an image is formed on an image plane 99. The filter 11 is, for example, an infrared cut-off filter, which allows light beam with appropriate wavelength (e.g. infrared light or visible light) to pass through while filtering out the infrared wavelength bands that are intended to be eliminated. The filter 11 is disposed between the lens 6 and the image plane 99. It should be clarified that the object side A1 is the side facing the object to be photographed, and the image side A2 is the side facing the image plane 99.

In this embodiment, the lens 1, the lens 2, the lens 3, the lens 4, the lens 5, the lens 6 and the filter 11 of the optical imaging lens 10 each have an object side surface 15, 25, 35, 45, 55, 65, 97 facing the object side A1 and allowing an imaging light beam to pass therethrough, and an image side surface 16, 26, 36, 46, 56, 66, 98 facing the image side A2 and allowing the imaging light beam to pass therethrough. In this embodiment, the aperture 0 is disposed on the object side A1 of the lens 1.

The first lens group 100 has positive refracting power and an effective focal length of 12.11 mm. The lens 1 has positive refracting power and an effective focal length of 15.34 mm. The optical axis region of the object side surface 15 is a convex surface, the optical axis region of the image side surface 16 is a concave surface, and both the object side surface 15 and the image side surface 16 are aspheric surfaces. The lens 2 has negative refracting power. The optical axis region of the object side surface 25 is a concave surface, the optical axis region of the image side surface 26 is a concave surface, and both the object side surface 25 and the image side surface 26 are aspherical surfaces. The lens 3 has positive refracting power. The optical axis region of the object side surface 35 is a convex surface, the optical axis region of the image side surface 36 is a convex surface, and both the object side surface 35 and the image side surface 36 are aspherical surfaces.

The second lens group 200 has negative refracting power. The lens 4 has negative refracting power. The optical axis region of the object side surface 45 is a concave surface, the optical axis region of the image side surface 46 is a concave surface, and both the object side surface 45 and the image side surface 46 are aspherical surfaces. The lens 5 has positive refracting power. The optical axis region of the object side surface 55 is a convex surface, the optical axis region of the image side surface 56 is a concave surface, and both the object side surface 55 and the image side surface 56 are aspherical surfaces. The lens 6 has negative refracting power. The optical axis region of the object side surface 65 is a concave surface, the optical axis region of the image side surface 66 is a convex surface, and both the object side surface 65 and the image side surface 66 are aspherical surfaces.

Other detailed optical data of the imaging lens 10 of the second embodiment in the wide-angle mode are shown in Table 7 and Table 8. The field of view (FOV) of the optical imaging lens 10 is 29°, the aperture value (F number) is 2.21, the total track length (TTL) of the lens (the distance from the object side surface 15 of the lens 1 to the image plane 99 on the optical axis I) is 19.90 mm, and the image height (ImgH) is 4.0 mm.

TABLE 7

| | | Radius of | | | |
|---|---|---|---|---|---|
| | | curvature | Spacing | Refractive | Abbe |
| Element | Surface | (mm) | (mm) | index | number |
| Object | | infinite | d0 | | |
| Aperture 0 | | infinite | −0.600 | | |
| Lens 1 | object side | 9.52 | 4.585 | 1.545 | 55.987 |
| | surface 15 | | | | |
| | image side | 664.36 | 1.874 | | |
| | surface 16 | | | | |
| Lens 2 | object side | −11.17 | 0.351 | 1.642 | 22.409 |
| | surface 25 | | | | |
| | image side | 22.03 | 0.322 | | |
| | surface 26 | | | | |
| Lens 3 | object side | 11.35 | 2.826 | 1.545 | 55.987 |
| | surface 35 | | | | |
| | image side | −6.45 | d7 | | |
| | surface 36 | | | | |
| Lens 4 | object side | −6.90 | 0.400 | 1.545 | 55.987 |
| | surface 45 | | | | |
| | image side | 33.87 | 0.976 | | |
| | surface 46 | | | | |
| Lens 5 | object side | 5.99 | 0.882 | 1.671 | 19.276 |
| | surface 55 | | | | |
| | image side | 16.45 | 1.897 | | |
| | surface 56 | | | | |
| Lens 6 | object side | −10.58 | 0.400 | 1.671 | 19.276 |
| | surface 65 | | | | |
| | image side | −238.88 | d13 | | |
| | surface 66 | | | | |
| Filter 11 | object side | infinite | 0.210 | 1.517 | 64.167 |
| | surface 97 | | | | |
| | image side | infinite | 0.800 | | |
| | surface 98 | | | | |
| | image plane 99 | infinite | | | |

TABLE 8

| Focus state | State 1 | State 2 |
|---|---|---|
| d0 | infinite | 500.00 |
| d7 | 3.06 | 3.73 |
| d13 | 1.32 | 0.65 |

In Table 7 and Table 8, the spacing of the object side surface 15 (4.585 mm as shown in Table 7) is the thickness of the lens 1 on the optical axis I, and the spacing of the image side surface 16 (1.874 mm as shown in Table 7) is the distance between the image side surface 16 of the lens 1 and the object side surface 25 of the lens 2 on the optical axis I, that is, the gap between the lens 1 and the lens 2 on the optical axis I, and so on. The object spacing d0 is the focal length of the imaging lens 10. Table 8 describes the values of d7 and d13 in Table 7 when the focal length of the imaging lens 10 is infinite (state 1) and 50 cm (state 2). State 1 in Table 8 corresponds to FIG. 10, and state 2 in Table 8 corresponds to FIG. 11.

In this embodiment, the object side surfaces 15, 25, 35, 45, 55, 65 and the image side surfaces 16, 26, 36, 46, 56, 66 of the lens 1, the lens 2, the lens 3, the lens 4, the lens 5, and the lens 6 are all aspherical surfaces, and these aspherical surfaces are defined according to the above Formula (1).

The conical coefficient K and various aspheric coefficients of the aspheric surface of the imaging lens 10 in Formula (1) of this embodiment are shown in Table 9. The number 15 in Table 9 indicates the aspheric coefficient of the object side surface 15 of the lens 1, and the other numbers may be deduced by analogy.

TABLE 9

| Surface | K | a₄ | a₆ | a₈ | a₁₀ |
|---|---|---|---|---|---|
| 15 | 0 | −2.2347E−01 | −3.9191E−01 | 3.6678E+00 | −2.6743E+01 |
| 16 | 0 | −9.9434E−01 | 1.4168E+00 | −1.2026E+01 | 6.4492E+01 |
| 25 | 0 | 3.5188E+00 | −4.2537E+01 | 2.2093E+02 | −7.1817E+02 |
| 26 | 0 | 3.8008E+00 | −3.4341E+01 | 1.1632E+02 | −1.3599E+02 |
| 35 | 0 | −2.9319E−01 | −7.3118E+00 | −3.6977E+00 | 1.3941E+02 |
| 36 | 0 | −2.0493E−01 | 2.7152E−01 | −1.0137E+01 | 6.3351E+01 |
| 45 | 0 | 1.2515E+01 | −6.6118E+01 | 2.5964E+02 | −6.9636E+02 |
| 46 | 0 | 1.2647E+01 | −5.9357E+01 | 1.5740E+02 | −6.9698E+01 |
| 55 | 0 | −4.3060E+00 | 1.6516E+01 | −2.8200E+01 | −9.5064E+01 |
| 56 | 0 | −4.7701E+00 | 1.9560E+01 | −1.7052E+01 | −1.8288E+02 |
| 65 | 0 | −9.9312E+00 | 9.1882E+01 | −3.8872E+02 | 9.9522E+02 |
| 66 | 0 | −9.3598E+00 | 1.8719E+02 | −1.1624E+03 | 3.7789E+03 |

| Surface | a₁₂ | a₁₄ | a₁₆ | a₁₈ | a₂₀ |
|---|---|---|---|---|---|
| 15 | 1.1184E+02 | −2.8047E+02 | 4.0594E+02 | −3.0606E+02 | 9.1963E+01 |
| 16 | −2.2096E+02 | 4.7638E+02 | −5.9968E+02 | 3.9416E+02 | −1.0367E+02 |
| 25 | 1.5979E+03 | −2.4886E+03 | 2.5403E+03 | −1.4760E+03 | 3.6251E+02 |
| 26 | −2.4080E+02 | 9.9827E+02 | −1.3309E+03 | 8.2285E+02 | −1.9868E+02 |
| 35 | −4.8381E+02 | 6.9222E+02 | −3.8890E+02 | −6.4965E−01 | 5.1432E+01 |
| 36 | −2.0568E+02 | 3.6723E+02 | −3.7293E+02 | 2.0055E+02 | −4.3792E+01 |
| 45 | 1.2775E+03 | −1.6624E+03 | 1.5179E+03 | −8.5916E+02 | 2.1827E+02 |
| 46 | −8.0296E+02 | 2.3484E+03 | −2.9839E+03 | 1.8635E+03 | −4.6523E+02 |
| 55 | 5.5188E+02 | −1.1498E+03 | 1.2705E+03 | −7.4308E+02 | 1.8100E+02 |
| 56 | 7.7091E+02 | −1.4335E+03 | 1.4673E+03 | −7.9867E+02 | 1.7918E+02 |
| 65 | −1.6886E+03 | 1.9406E+03 | −1.4696E+03 | 6.5732E+02 | −1.2851E+02 |
| 66 | −6.9688E+03 | 6.8084E+03 | −2.5835E+03 | −5.8326E+02 | 5.2861E+02 |

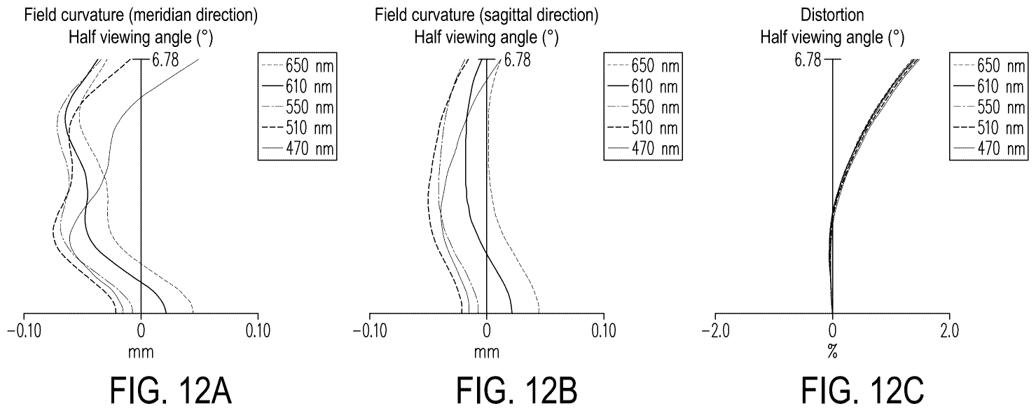

Referring to FIG. 12A, FIG. 12B and FIG. 12C, which respectively show a schematic diagram of field curvature in the meridional direction, a schematic diagram of field curvature in the sagittal direction and a schematic diagram of distortion when the focal length of the imaging lens 10 of the second embodiment is infinite (corresponding to state 1 and FIG. 10). As shown in FIG. 12A and FIG. 12B, when light with wavelengths of 470 nm, 510 nm, 555 nm, 610 nm and 650 nm respectively enter the imaging lens 10, the field curvatures at different field of views are within the range of ±0.08 mm. As shown in FIG. 12C, the distortion aberration of the imaging lens 10 is maintained within the range of ±1.6%.

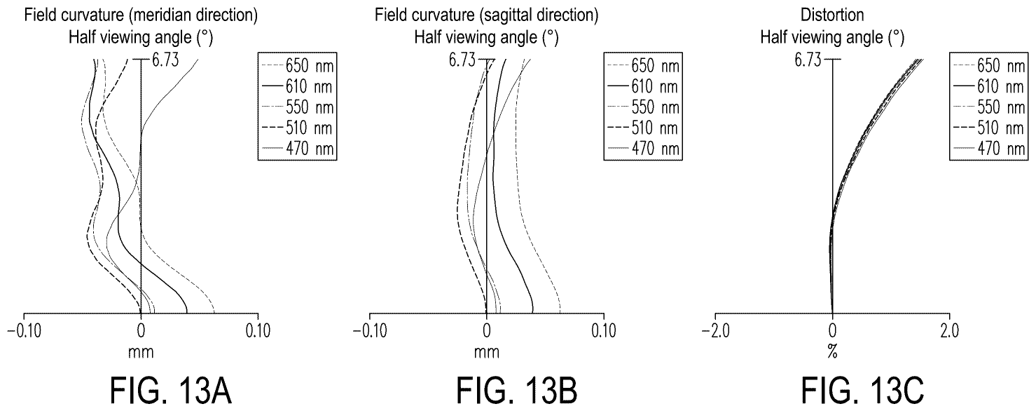

Referring to FIG. 13A, FIG. 13B and FIG. 13C, which respectively show a schematic diagram of field curvature in the meridional direction, a schematic diagram of field curvature in the sagittal direction and a schematic diagram of distortion when the focal length of the imaging lens 10 of the second embodiment is 50 cm (corresponding to state 2 and FIG. 11). As shown in FIG. 13A and FIG. 13B, when light with wavelengths of 470 nm, 510 nm, 555 nm, 610 nm and 650 nm respectively enter the imaging lens 10, the field curvatures at different field of views are within the range of ±0.08 mm. As shown in FIG. 13C, the distortion aberration of the imaging lens 10 is maintained within the range of ±1.6%.

FIG. 12A to FIG. 13C illustrate that the imaging lens 10 according to the second embodiment of the disclosure has good imaging quality in the wide-angle mode and a short total track length.

Optical schematic diagrams of the imaging lens 10 in the telephoto mode according to the second embodiment of the disclosure are shown in FIG. 14 and FIG. 15. The imaging lens 10 includes an aperture 0, a lens 7, a lens 8, a lens 9, a lens 4, a lens 5, a lens 6 and a filter 11 in sequence along the optical axis I of the imaging lens 10 from the object side A1 to the image side A2. When a light beam emitted by an object to be photographed enters the imaging lens 10 and sequentially passes through the aperture 0, the lens 7, the lens 8, the lens 9, the lens 4, the lens 5, the lens 6 and the filter 11, an image is formed on an image plane 99. The filter 11 is disposed between the lens 6 and the image plane 99.

In this embodiment, the lens 7, the lens 8, the lens 9, the lens 4, the lens 5, the lens 6 and the filter 11 of the optical imaging lens 10 each have an object side surface 75, 85, 95, 45, 55, 65, 97 facing the object side A1 and allowing an imaging light beam to pass therethrough, and an image side surface 76, 86, 96, 46, 56, 66, 98 facing the image side A2 and allowing the imaging light beam to pass therethrough. In this embodiment, the aperture 0 is disposed on the object side A1 of the lens 7.

The third lens group 300 has positive refracting power and an effective focal length of 15.72 mm. The lens 7 has positive refracting power and an effective focal length of 10.93 mm. The optical axis region of the object side surface 75 is a convex surface, the optical axis region of the image side surface 76 is a convex surface, and both the object side surface 75 and the image side surface 76 are aspheric surfaces. The lens 8 has negative refracting power. The optical axis region of the object side surface 85 is a concave surface, the optical axis region of the image side surface 86 is a concave surface, and both the object side surface 85 and the image side surface 86 are aspherical surfaces. The lens 9 has positive refracting power. The optical axis region of the object side surface 95 is a concave surface, the optical axis region of the image side surface 96 is a convex surface, and both the object side surface 95 and the image side surface 96 are aspherical surfaces.

Other detailed optical data of the imaging lens 10 of the second embodiment in the telephoto mode are shown in Table 10 and Table 11. The field of view (FOV) of the optical imaging lens 10 is 15°, the aperture value (F number) is 4.17, the total track length (TTL) of the lens (the distance from the object side surface 75 of the lens 7 to the image plane 99 on the optical axis I) is 23.897 mm, and the image height (ImgH) is 4.0 mm.

TABLE 10

| | | Radius of | | | |
|---|---|---|---|---|---|
| | | curvature | Spacing | Refractive | Abbe |
| Element | Surface | (mm) | (mm) | index | number |
| Object | | infinite | d0 | | |
| Aperture 0 | | infinite | −1.000 | | |
| Lens 7 | object side | 7.16 | 1.525 | 1.545 | 55.987 |
| | surface 75 | | | | |
| | image side | −24.43 | 0.780 | | |
| | surface 76 | | | | |
| Lens 8 | object side | −17.34 | 0.400 | 1.642 | 22.409 |
| | surface 85 | | | | |
| | image side | 36.33 | 6.502 | | |
| | surface 86 | | | | |
| Lens 9 | object side | −22.77 | 0.914 | 1.545 | 55.987 |
| | surface 95 | | | | |
| | image side | −10.24 | d7 | | |
| | surface 96 | | | | |
| Lens 4 | object side | −6.90 | 0.400 | 1.545 | 55.987 |
| | surface 45 | | | | |
| | image side | 33.87 | 0.976 | | |
| | surface 46 | | | | |
| Lens 5 | object side | 5.99 | 0.882 | 1.671 | 19.276 |
| | surface 55 | | | | |
| | image side | 16.45 | 1.897 | | |
| | surface 56 | | | | |
| Lens 6 | object side | −10.58 | 0.400 | 1.671 | 19.276 |
| | surface 65 | | | | |
| | image side | −238.88 | d13 | | |
| | surface 66 | | | | |
| Filter 11 | object side | infinite | 0.210 | 1.517 | 64.167 |
| | surface 97 | | | | |
| | image side | infinite | 0.800 | | |
| | surface 98 | | | | |
| | image plane 99 | infinite | | | |

TABLE 11

| Focus state | State 1 | State 2 |
|---|---|---|
| d0 | infinite | 500.00 |
| d7 | 0.10 | 0.79 |
| d13 | 8.11 | 7.42 |

In Table 10 and Table 11, the spacing of the object side surface 75 (1.525 mm as shown in Table 10) is the thickness of the lens 7 on the optical axis I, and the spacing of the image side surface 76 (0.780 mm as shown in Table 10) is the distance between the image side surface 76 of the lens 7 and the object side surface 85 of the lens 8 on the optical axis I, that is, the gap between the lens 7 and the lens 8 on the optical axis I, and so on. The object spacing d0 is the focal length of the imaging lens 10. Table 11 describes the values of d7 and d13 in Table 10 when the focal length of the imaging lens 10 is infinite (state 1) and 50 cm (state 2). State 1 in Table 11 corresponds to FIG. 14, and state 2 in Table 11 corresponds to FIG. 15.

In this embodiment, the object side surfaces 75, 85, 95, 45, 55, 65 and the image side surfaces 76, 86, 96, 46, 56, 66 of the lens 7, the lens 8, the lens 9, the lens 4, the lens 5, and the lens 6 are all aspherical surfaces. The conical coefficient K and various aspheric coefficients of the aspheric surface of the imaging lens 10 in Formula (1) of this embodiment are shown in Table 12. The number 75 in Table 12 indicates the aspheric coefficient of the object side surface 75 of the lens 7, and the other numbers may be deduced by analogy.

TABLE 12

| Surface | K | a₄ | a₆ | a₈ | a₁₀ |
|---|---|---|---|---|---|
| 75 | 0 | 2.0979E−01 | −1.9793E+00 | 9.7228E+00 | −1.1629E+01 |
| 76 | 0 | 1.4825E+00 | −1.6697E+01 | 1.1088E+02 | −3.7278E+02 |
| 85 | 0 | 4.0083E+00 | −5.4336E+01 | 4.1777E+02 | −1.8094E+03 |
| 86 | 0 | 2.3569E+00 | −2.9039E+01 | 2.0298E+02 | −8.1053E+02 |
| 95 | 0 | −2.7444E+00 | −9.7980E+00 | 8.2521E+01 | −5.3302E+02 |
| 96 | 0 | −2.0872E+00 | −9.4987E+00 | 8.3773E+01 | −4.8225E+02 |
| 45 | 0 | 1.2515E+01 | −6.6118E+01 | 2.5964E+02 | −6.9636E+02 |
| 46 | 0 | 1.2647E+01 | −5.9357E+01 | 1.5740E+02 | −6.9698E+01 |
| 55 | 0 | −4.3060E+00 | 1.6516E+01 | −2.8200E+01 | −9.5064E+01 |
| 56 | 0 | −4.7701E+00 | 1.9560E+01 | −1.7052E+01 | −1.8288E+02 |
| 65 | 0 | −9.9312E+00 | 9.1882E+01 | −3.8872E+02 | 9.9522E+02 |
| 66 | 0 | −9.3598E+00 | 1.8719E+02 | −1.1624E+03 | 3.7789E+03 |

| Surface | a₁₂ | a₁₄ | a₁₆ | a₁₈ | a₂₀ |
|---|---|---|---|---|---|
| 75 | −7.9987E+00 | 9.1708E+01 | −2.0627E+02 | 1.8421E+02 | −5.7855E+01 |
| 76 | 7.3524E+02 | −9.0680E+02 | 6.8192E+02 | −2.8217E+02 | 4.8776E+01 |
| 85 | 4.5977E+03 | −7.0804E+03 | 6.5222E+03 | −3.3054E+03 | 7.0807E+02 |
| 86 | 1.8850E+03 | −2.5979E+03 | 2.0893E+03 | −9.0246E+02 | 1.6112E+02 |
| 95 | 1.8848E+03 | −3.6753E+03 | 4.0213E+03 | −2.3198E+03 | 5.4946E+02 |
| 96 | 1.6102E+03 | −3.1135E+03 | 3.4707E+03 | −2.0699E+03 | 5.1036E+02 |
| 45 | 1.2775E+03 | −1.6624E+03 | 1.5179E+03 | −8.5916E+02 | 2.1827E+02 |
| 46 | −8.0296E+02 | 2.3484E+03 | −2.9839E+03 | 1.8635E+03 | −4.6523E+02 |
| 55 | 5.5188E+02 | −1.1498E+03 | 1.2705E+03 | −7.4308E+02 | 1.8100E+02 |
| 56 | 7.7091E+02 | −1.4335E+03 | 1.4673E+03 | −7.9867E+02 | 1.7918E+02 |
| 65 | −1.6886E+03 | 1.9406E+03 | −1.4696E+03 | 6.5732E+02 | −1.2851E+02 |
| 66 | −6.9688E+03 | 6.8084E+03 | −2.5835E+03 | −5.8326E+02 | 5.2861E+02 |

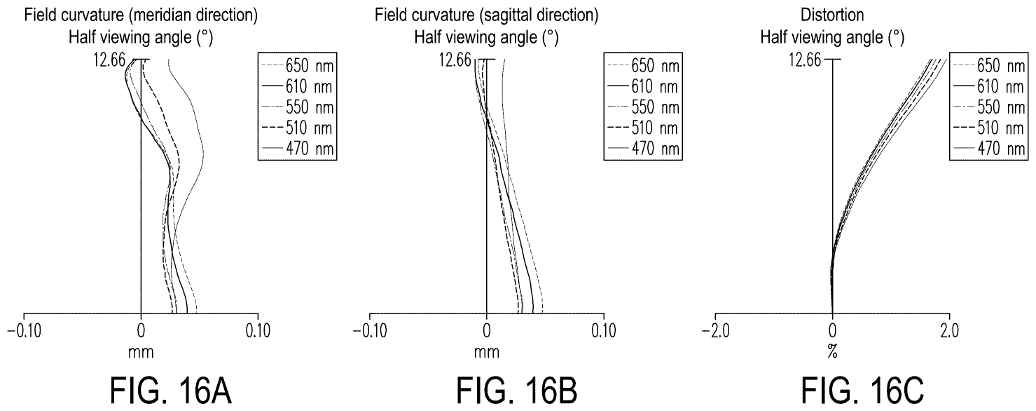

Referring to FIG. 16A, FIG. 16B and FIG. 16C, which respectively show a schematic diagram of field curvature in the meridional direction, a schematic diagram of field curvature in the sagittal direction and a schematic diagram of distortion when the focal length of the imaging lens 10 of the second embodiment is infinite (corresponding to state 1 and FIG. 14). As shown in FIG. 16A and FIG. 16B, when light with wavelengths of 470 nm, 510 nm, 555 nm, 610 nm and 650 nm respectively enter the imaging lens 10, the field curvatures at different field of views are within the range of ±0.06 mm. As shown in FIG. 16C, the distortion aberration of the imaging lens 10 is maintained within the range of ±2.0%.

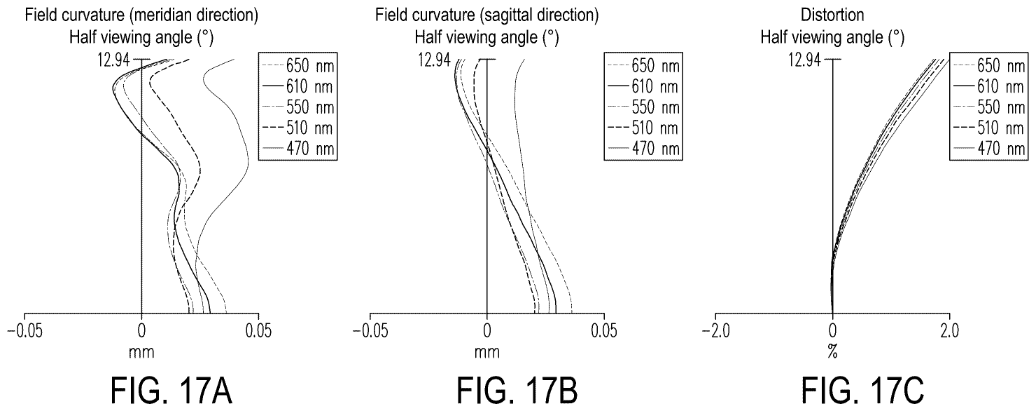

Referring to FIG. 17A, FIG. 17B and FIG. 17C, which respectively show a schematic diagram of field curvature in the meridional direction, a schematic diagram of field curvature in the sagittal direction and a schematic diagram of distortion when the focal length of the imaging lens 10 of the second embodiment is 10 cm (corresponding to state 2 and FIG. 15). As shown in FIG. 17A and FIG. 17B, when light with wavelengths of 470 nm, 510 nm, 555 nm, 610 nm and 650 nm respectively enter the imaging lens 10, the field curvatures at different field of views are within the range of ±0.05 mm. As shown in FIG. 17C, the distortion aberration of the imaging lens 10 is maintained within the range of ±2.0%.

FIG. 16A to FIG. 17C illustrate that the imaging lens 10 according to the second embodiment of the disclosure has good imaging quality in the telephoto mode and a short total track length.

Based on the above, the imaging lens provided by the embodiment of the disclosure may switch the first lens group and the third lens group to achieve the purpose of zooming. Compared to traditional imaging lenses that require a total track length of at least 30 mm at the same zoom ratio, the total track length of each embodiment of the disclosure does not exceed 24 mm, achieving high resolution and zoom ratio within a compact volume.

What is claimed is:

1. An imaging lens, comprising a first lens group and a second lens group, wherein
the first lens group has positive refracting power and comprises a first lens, a second lens and a third lens having refracting power,
the second lens group has negative refracting power and comprises a fourth lens, a fifth lens and a sixth lens having refracting power,
the first lens to the sixth lens are disposed in sequence from an object side to an image side of the imaging lens, and
a light beam passes through a total of six lenses with refracting power when the light beam enters the imaging lens from the object side of the imaging lens and reaches an image plane.

2. The imaging lens according to claim 1, wherein the second lens group moves as a whole group along an optical axis, and the first lens group does not move when the imaging lens focuses.

3. The imaging lens according to claim 1, wherein the first lens has positive refracting power.

4. The imaging lens according to claim 1, wherein the second lens has negative refracting power.

5. The imaging lens according to claim 1, wherein the third lens has positive refracting power.

6. The imaging lens according to claim 1, wherein the fourth lens has negative refracting power.

7. The imaging lens according to claim 1, wherein the fifth lens has positive refracting power.

8. The imaging lens according to claim 1, wherein the sixth lens has negative refracting power.

9. The imaging lens according to claim 1, further comprising a third lens group and a lens group replacement mechanism, wherein the lens group replacement mechanism is configured to replace the first lens group with the third lens group on an optical axis of the imaging lens, and to replace the third lens group with the first lens group on the optical axis; the imaging lens is in a wide-angle mode when the first lens group is disposed on the optical axis; the imaging lens is in a telephoto mode when the third lens group is disposed on the optical axis.

10. The imaging lens according to claim 9, wherein the third lens group has positive refracting power and comprises a seventh lens, an eighth lens, and a ninth lens having refracting power.

11. The imaging lens according to claim 10, wherein the imaging lens has a first total track length TTL1 when the imaging lens is in the wide-angle mode; the imaging lens has a second total track length TTL2 when the imaging lens is in the telephoto mode; the imaging lens satisfies a conditional formula 0.8*TTL2≤TTL1≤TTL2.

12. The imaging lens according to claim 10, wherein the imaging lens has a first image height ImgH1 when the imaging lens is in the wide-angle mode; the imaging lens has a second image height ImgH2 when the imaging lens is in the telephoto mode; the imaging lens satisfies a conditional formula 0.7*ImgH1≤ImgH2≤ImgH1.

13. The imaging lens according to claim 10, wherein the seventh lens has a first effective focal length EFL1, the first lens has a second effective focal length EFL2, the imaging lens satisfies a conditional formula 0.5*EFL2≤EFL1<EFL2.

14. The imaging lens according to claim 9, wherein the first lens group has a first effective focal length EFL1, the third lens group has a second effective focal length EFL2, the imaging lens satisfies a conditional formula 0.75*EFL2≤EFL1<EFL2.
